(19) United States
(12) Patent Application Publication
(10) Pub. No.: US 2014/0352206 A1
(43) Pub. Date: Dec. 4, 2014

(54) APPARATUS AND METHODS FOR TREATING SOLIDS BY ELECTROMAGNETIC RADIATION

(71) Applicant: MICROCOAL, INC., Vancouver (CA)

(72) Inventor: Ben Zion Livneh, Denver, CO (US)

(21) Appl. No.: 14/368,597

(22) PCT Filed: Jan. 28, 2013
(86) PCT No.: PCT/US2013/023436

§ 371 Date: Jun. 25, 2014

Related U.S. Application Data
(60) Provisional application No. 61/590,997, filed on Jan. 26, 2012.

(51) Int. Cl. B01J 19/12; C10L 5/28

(52) U.S. Cl. CPC B01J 19/126; C10L 5/28; B01J 2219/1221
USPC 44/492; 44/626; 44/630; 44/629; 44/605

(57) ABSTRACT

Embodiments of the present invention are directed to methods and apparatus for subjecting coarsely divided solid material, such as solid fossil fuels, to microwave radiation using gravity feed through a chamber and protecting irradiating windows by placement outside the angle of repose.

### FIELD OF THE INVENTION

Embodiments of the present invention are directed to apparatus and methods of treating a solid material by exposing the solid material to electromagnetic radiation (EMR). The solid material's properties are improved by the exposure to EMR. EMR comprises radio frequency (RF) or microwave radiation. For example, without limitation, solid fossil fuels (SFF), including (but not limited to) coal, are improved through its exposure to EMR, to remove water and/or other impurities.

### BACKGROUND OF THE INVENTION

Coal and other fossil fuels are mined with impurities and water content that can limit their use or lead. However, apparatus and processes for removing such impurities and water content can be awkward and expensive.

It would be useful to have apparatus and methods for removing impurities and water content from coal and other fossil fuels that can be readily adapted to existing facilities which use such fossil fuels.

### BRIEF SUMMARY OF THE INVENTION

Embodiments of the present invention feature apparatus and methods for removing impurities and water content from coal, fossil fuels and cellular biomass that can be readily adapted to existing facilities. One embodiment of the present invention, directed to an apparatus for exposing a coarsely divided solid material to radiation, has a housing having one or more walls forming a chamber having a top, midsection and a bottom. The chamber has a fill opening for receiving the coarsely divided solid material which fill opening is located proximal to the top. The chamber has an exit opening for discharging coarsely divided solid material which exit opening is located proximal to the bottom. The midsection extends between the top and bottom for retaining a working volume of the coarsely divided solid material as the coarsely divided solid material moves therethrough by gravity. The movement of the coarsely divided solid material through the chamber defines a range of movement, and the chamber has at least one side cavity extending outside the range of movement. The cavity has at least one window for receiving radiation from a radiation source and passing the radiation into the chamber to the coarsely divided solid material, for subjecting a coarsely divided solid material to radiation as it moves through the chamber of said housing by gravity.

Embodiments of the present apparatus have particular utility wherein the coarsely divided solid material is selected from the group of solid fuels consisting of coal, shale, peat, wood, and cellulosic biomass. Microwave radiation removes water and other impurities upgrading such fuels for more efficient combustion.

One embodiment of the present invention features an apparatus further comprising a source of radiation, such as a RF or microwave generator.

One embodiment of the present invention features an apparatus wherein the chamber has a vent for removing gases generated by irradiation.

A further embodiment features an apparatus of wherein the chamber is in fluid communication with a source of inert gas to reduce combustion. For the purpose of this application, the term “inert gas” means not readily capable of participating in combustion processes. Such gases would include the gases commonly known as “noble” gases but also comprise relatively non-combustable gases, such as carbon dioxide and nitrogen.

One embodiment of the present invention further features an apparatus comprising a flow controller to control the rate of movement of the coarsely divided solid material through the chamber. The flow controller may take several forms such as, by way of example, without limitation, one or more gates which open or close or decrease the size of the exit opening to control the rate of the movement of the coarsely divided solid material. Other embodiments feature a flow controller in the form of conveying means which receives the coarsely divided solid material and determines the rate of removal from said chamber. For example, without limitation, one conveying means comprises one or more of the group of consisting of endless belts, rotating blades, rollers, moving vessels or combinations thereof.

Thus, the chamber is loaded with a coarsely divided solid material which has an angle of repose preventing the coarsely divided solid material from engaging the window in the cavity allowing the coarsely divided solid material to be irradiated as the material passes the cavity by gravity.

A further embodiment of the present invention is directed to a method for exposing a coarsely divided solid material to radiation. The method comprising the steps of providing an apparatus having a housing with one or more walls forming a chamber having a top, midsection and a bottom. The chamber has a fill opening for receiving the coarsely divided solid material located proximal to the top and an exit opening for discharging coarsely divided solid material located proximal to the bottom. The midsection extends between the top and bottom for retaining a working volume of the coarsely divided solid material as the coarsely divided solid material moves therethrough by gravity. The movement of coarsely divided solid material defines a range of movement. The chamber has at least one side cavity extending outside the range of movement and the cavity has at least one window for receiving radiation from a radiation source and passing the radiation into the chamber to the coarsely divided solid material, for subjecting a coarsely divided solid material to radiation as it moves through the chamber of the housing by gravity. The method further comprises the steps of directing a coarsely divided solid material into the chamber through the fill opening, and through the midsection; irradiating the coarsely divided material as the material passes the cavity by directing radiation through the window from a radiation source to produce a irradiated solid material; and, passing the irradiated solid material through the exit opening.

Embodiments of the present method have particular utility wherein the coarsely divided solid material is selected from the group of solid fuels consisting of coal, shale, peat, wood, and cellulosic biomass. RF or microwave radiation removes water and other impurities for more efficient combustion.

Embodiments of the present invention further comprise a method wherein the apparatus further comprising a source of radiation, such as a RF or microwave generator.

Further embodiments comprise a method wherein said chamber has a vent for removing gases generated by irradiation and the method comprises the step of removing the gases through the vent.

A further embodiment comprises a method wherein the chamber is in fluid communication with a source of inert gas and the method comprises the step of placing an inert gas in said chamber to reduce combustion. As used herein, the term “reduce combustion” includes eliminating combustion, dampening combustion processes that are taking place, and making combustion processes unlikely to occur due to removal or displacement of oxygen by inert gases. One embodiment of the present method features the use of carbon dioxide and nitrogen as inert gases.

A further embodiment of the invention is directed to a method wherein the apparatus further comprises a flow controller to control the rate of movement of the coarsely divided solid material through the chamber and the method comprises the step of controlling the movement of said coarsely divided solid material to subject the coarsely divided solid material to a predetermined amount of radiation. For example, without limitation, one method features a flow controller having one or more gates which open or close or decrease the size of the exit opening to control the rate of the movement of the coarsely divided solid material. Other embodiments feature a flow controller in the form of conveying means which receives the coarsely divided solid material and determines the rate of removal from the chamber. Examples of such conveying means are endless belts, rotating blades, rollers, moving vessels and the like and combinations thereof.

Thus, one embodiment of the present method features the steps of loading the chamber with a coarsely divided solid material which has an angle of repose preventing said coarsely divided solid material from engaging said window located in a cavity allowing said coarsely divided solid material to be irradiated as the material passes the cavity by gravity.

These and other features and advantages of the present invention will be apparent to those skilled in the art upon viewing the Figure, described briefly below, and upon reading the Detailed Description which follows.

### BRIEF DESCRIPTION OF THE DRAWING

FIG. 1 depicts an apparatus embodying features of the present invention.

FIG. 2 is a slightly elevated, side view of the apparatus of FIG. 1.

### DETAILED DESCRIPTION OF THE INVENTION

Embodiments of the present invention will be described in detail with respect to apparatus and methods for subjecting a coarsely divided solid material to electromagnetic radiation. The apparatus and method will be described in detail with respect to coal, and other solid fossil fuels such as by way of example wood, charcoal, cellular biomass, shale, peat and the like.

The apparatus and method have utility for subjecting coal to microwave to improve the coal's attributes (such as heat value) by reducing the coal's inherent moisture, and to make the coal more valuable. Subjecting coal to microwave radiation changes the coal's mineralogy thereby improving combustion efficiency, reducing environmental impact, and improving the combustion chamber's operation. Coal and other solid fossil fuels are used in combustion processes to produce steam and in kilns in cement and lime production.

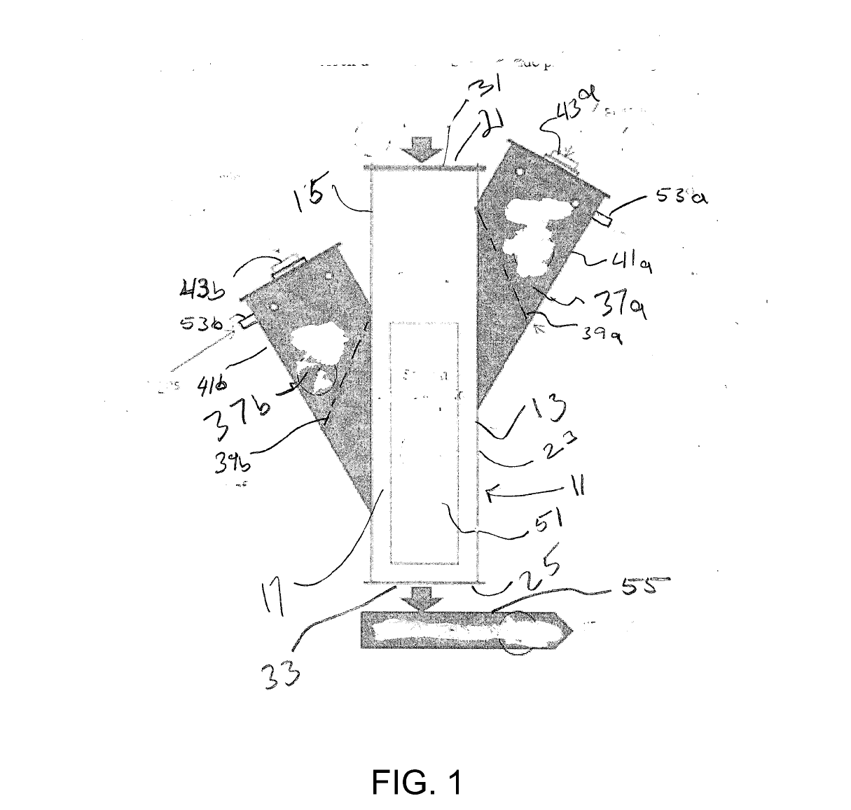

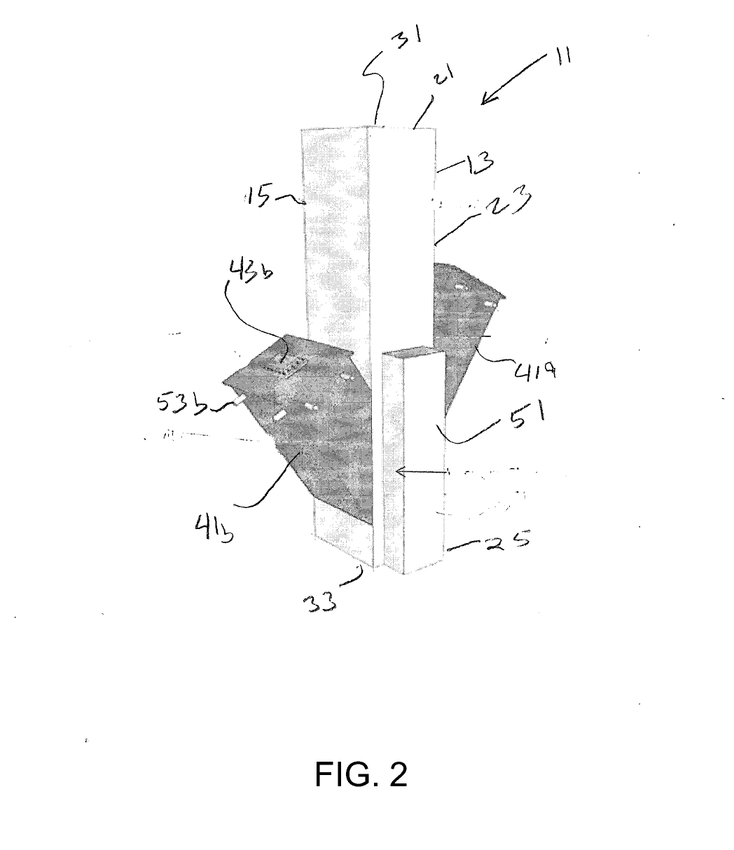

One embodiment of the present invention, directed to an apparatus for exposing a coarsely divided solid material to radiation, is depicted in FIGS. 1 and 2, generally designated by the numeral 11. The apparatus 11 has a housing 13 having one or more walls 15 forming a chamber 17 having a top 21, midsection 23 and a bottom 25. The housing 13, sized for industrial applications such as coal processing, is approximately three meters in height, about one meter in width and one to two meters in depth. It is constructed of suitable materials such as steel and steel alloys. The shape and form of the chamber 17 is such as to minimize or eliminate interaction of the steel with electromagnetic radiation.

The chamber 17 has a fill opening 31 for receiving the coarsely divided solid material. The fill opening 31 is proximal to the top 21. Similarly, the chamber 17 has an exit opening 33 for discharging coarsely divided solid material. The exit opening 33 is located proximal to the bottom 25. The midsection 23 extends between the top 21 and bottom 25 for retaining a working volume of the coarsely divided solid material as the coarsely divided solid material moves therethrough by gravity.

The movement of the coarsely divided solid material through the chamber 17 defines a range of movement. That is, the coarsely divided solid material occupies space as it moves through the chamber 17. Referring now to FIG. 1, the chamber 17 has at least one side cavity, of which two are depicted, designated 37a and 37b. Cavity 37a and 37b are formed by housing protrusions 41a and 41b. The housing protrusions 41a and 41b and the cavity 37a and 37b formed thereof extend beyond the angle of repose of the solid material occupying the chamber 17. The angle of repose for coarsely divided solid material is generally thirty to fifty degrees from the horizontal and is generally designated by the numeral 39a and 39b in FIG. 1. Each cavity 37a and 37b extends in a generally upward angle to allow each cavity 37a and 37b to turnover the solid material flowing into the cavity with material flowing downward through the chamber 17.

Each cavity 37a and 37b has at least one window 43a and 43b, respectively, for receiving radiation from a radiation source [not shown] such as a magnetron tube known in the art. Each window 43a and 43b passes the radiation into the chamber 17 to the coarsely divided solid material moving about the angle of repose as the coarsely divided solid material moves through the chamber 17 of the housing 13 by gravity. High power microwave energy is generated by a magnetron tube that operates at high voltage in a microwave generator, and is transmitted through waveguides and through the windows 43a and 43b to each cavity 37a and 37b, where it is received by the coarsely divided solid material interact (such as coal). EMR transparent windows 43a and 43b keep the waveguide and its upstream components clean of dust. The materials of construction of the windows 43a and 43b are EMR transparent material (such as ceramics or quartz).

The typical coarsely divided solid material is “dirty” and includes dust. If dust penetrates the waveguide or the microwave generator system where high power microwaves exist, it can cause damage to the delicate components. The present invention features construction and arrangement of the delicate components of the apparatus 11—i.e. the microwave generator and waveguide on one hand, and the cavities 37a and 37b where the coarsely divided solid material is presented on the other hand—separated to keep the microwave section clean and clear of any fugitive dust, while allowing microwave energy to move freely from the clean microwave section to the dirty section.

One embodiment of the present invention features an apparatus 11 further comprising a source of radiation, such as a RF or microwave generator [not shown]. Microwave generators or magnetron tubes are well known in the art and are available in several power ranges. A typical microwave generator used as part of or in conjunction with apparatus 11 has 50 kilowatts of power.

The chamber 17 has a vent 51 for removing gases generated by irradiation. Vent 51 is equipped with screening and grates [not shown] to retain solids in the chamber 17 and allow vapors and gases to exit. The vent 51 is placed in fluid communication with pumps or fans [not shown] for placing the vent 51 and chamber 17 under low pressure to withdraw gases.

The chamber 17 is in fluid communication with a source of inert gas to reduce combustion. Housing extensions 41a and 41b have inert gas conduits of which two are depicted in FIG. 1 and denoted 53a and 53b respectively. For the purpose of this application, the term “inert gas” means not readily capable of participating in combustion processes. Such gases would include the gases commonly known as “noble” gases but also comprise relatively non-combustible gases, such as carbon dioxide and nitrogen. The inert gas conduits 53a and 53b are preferably directed to create gas currents which carry dust and dirt away from the windows 43a and 43b.

The inert gas conduits 53a and 53b flush the chamber 17 with an inert gas to minimize or eliminate potential combustion. The inert gas is removed through the vent 51.

Apparatus 11 further comprises a flow controller, generally designated by the numeral 55, to control the rate of movement of the coarsely divided solid material through the chamber 17. The flow controller 55 may take several forms such as, by way of example, without limitation, one or more gates [not shown] which open or close or decrease the size of the exit opening 33 to control the rate of the movement of the coarsely divided solid material. Other embodiments feature a flow controller 55 in the form of conveying means which receives the coarsely divided solid material and determines the rate of removal from the chamber 17. For example, without limitation, one conveying means [not shown] comprises one or more of the group of consisting of endless belts, rotating blades, rollers, moving vessels or combinations thereof.

Thus, the chamber 17 is loaded with a coarsely divided solid material which has an angle of repose 39a and 39b preventing the coarsely divided solid material from engaging each window 43a and 43b in each cavity 37a and 37b allowing the coarsely divided solid material to be irradiated as the material passes through the cavity 17 by gravity.

Embodiments of the present apparatus 11 have particular utility wherein the coarsely divided solid material is selected from the group of solid fuels consisting of coal, shale, peat, wood, and cellulosic biomass. Microwave radiation removes water and other impurities upgrading such fuels for more efficient combustion.

The method will be described in detail with respect to the operation of apparatus 11 for exposing a coarsely divided solid material to microwave radiation. The method comprises the step of providing an apparatus 11 having a housing 13 with one or more walls 15 forming a chamber 17. The chamber 17 has a top 21, midsection 23 and a bottom 25. The chamber 17 has a fill opening 31 for receiving the coarsely divided solid material located proximal to the top 21 and an exit opening 33 for discharging coarsely divided solid material located proximal to the bottom 25. The midsection 23 extends between the top 21 and bottom 25 for retaining a working volume of the coarsely divided solid material as the coarsely divided solid material moves therethrough by gravity. The movement of coarsely divided solid material defines a range of movement. The chamber 17 has at least one side cavity of which two are depicted 37a and 37b extending outside the range of movement. Each cavity 37a and 37b has at least one window 43a and 43b for receiving radiation from a radiation source [not shown] and passing the radiation into the chamber 17 to the coarsely divided solid material, for subjecting a coarsely divided solid material to radiation as it moves through the chamber 17 of the housing 13 by gravity. The method further comprises the steps of directing a coarsely divided solid material into the chamber 17 through the fill opening 31, and through the midsection 23; irradiating the coarsely divided material as the material passes the cavities 37a and 37b by directing radiation through the windows 43a and 43b from a radiation source to produce a irradiated solid material; and, passing the irradiated solid material through the exit opening 33.

Preferably, the method comprises the step of removing gases formed during irradiation through vent 51.

Preferably, the method, wherein the chamber 17 is in fluid communication with a source of inert gas comprises the step of placing an inert gas in the chamber 17 to reduce combustion.

Preferably, the method, wherein the apparatus 11 further comprises a flow controller 55 comprises the step of controlling the movement of said coarsely divided solid material to subject the coarsely divided solid material to a predetermined amount of radiation.

Thus, one embodiment of the present method features the steps of loading the chamber 17 with a coarsely divided solid material which has an angle of repose 39a and 39b preventing said coarsely divided solid material from engaging said windows 43a and 43b located in a cavities 37a and 37b allowing said coarsely divided solid material to be irradiated as the material passes the cavity 37a and 37b by gravity. Embodiments of the present method have particular utility wherein the coarsely divided solid material is selected from the group of solid fuels consisting of coal, shale, peat, wood, and cellulosic biomass. RF or microwave radiation removes water and other impurities for more efficient combustion.

Thus, embodiments of the present invention have been described in detail with the understanding that the descriptions herein have been directed to the preferred embodiments and what the inventor considers the best mode. The present invention is subject to alteration and modification and the best mode may change over time. Therefore, that the present disclosure should not be considered limiting, but should encompass the subject matter of the claims that follow and their equivalents.

1. An apparatus for exposing a coarsely divided solid material to radiation comprising:
a housing having one or more walls forming a chamber having a top, midsection and a bottom, said chamber having a fill opening for receiving said coarsely divided solid material located proximal to the top and an exit opening for discharging coarsely divided solid material located proximal to the bottom, said midsection extending between said top and bottom for retaining a working volume of said coarsely divided solid material as said coarsely divided solid material moves therethrough by gravity and defining a range of movement, said chamber having at least one side cavity extending outside the range of movement and having at least one window for receiving radiation from a radiation source and passing said radiation into said chamber to said coarsely divided solid material, for subjecting a coarsely divided solid material to radiation as the coarsely divided solid material moves through the chamber of said housing by gravity.

2. The apparatus of claim 1 further comprising a source of radiation.

3. The apparatus of claim 2 wherein said source of radiation is a microwave generator.

4. The apparatus of claim 1 wherein said coarsely divided solid material is selected from the group of solid fuels consisting of coal, shale, peat, wood, and cellulosic biomass.

5. The apparatus of claim 1 wherein said chamber has a vent for removing gases generated by irradiation.

6. The apparatus of claim 1 wherein said chamber is in fluid communication with a source of inert gas to reduce combustion.

7. The apparatus of claim 6 wherein said inert gas is selected from the group comprising nitrogen and carbon dioxide.

8. The apparatus of claim 1 further comprising a flow controller to control the rate of movement of said coarsely divided solid material through said chamber.

9. The apparatus of claim 8 wherein said flow controller is one or more gates which open or close or decrease the size of said exit opening to control the rate of the movement of said coarsely divided solid material.

10. The apparatus of claim 8 wherein said flow controller is conveying means which receives said coarsely divided solid material and determined the rate of removal from said chamber.

11. The apparatus of claim 10 wherein said conveying means is selected from one or more of the group of consisting of endless belts, rotating blades, moving vessels.

12. The apparatus of claim 1 wherein said chamber is loaded with a coarsely divided solid material which has an angle of repose preventing said coarsely divided solid material from engaging said window allowing said coarsely divided solid material to be irradiated as said material passes said cavity by gravity.

13. A method for exposing a coarsely divided solid material to radiation comprising the steps of:
providing an apparatus having a housing having one or more walls forming a chamber having a top, midsection and a bottom, said chamber having a fill opening for receiving said coarsely divided solid material located proximal to the top and an exit opening for discharging coarsely divided solid material located proximal to the bottom, said midsection extending between said top and bottom for retaining a working volume of said coarsely divided solid material as said coarsely divided solid material moves therethrough by gravity and defining a range of movement, said chamber having at least one side cavity extending outside the range of movement and having at least one window for receiving radiation from a radiation source and passing said radiation into said chamber to said coarsely divided solid material, for subjecting a coarsely divided solid material to irradiation as said coarsely divided solid material moves through the chamber of said housing by gravity;
directing a coarsely divided solid material into chamber through said fill opening, and through said midsection;
irradiating said coarsely divided material as said passes said cavity by directing radiation through said window from a radiation source to produce a irradiated solid material; and,
passing said irradiated solid material through said exit opening.

14. The method of claim 13 wherein said apparatus further comprising a source of radiation.

15. The method of claim 13 wherein said source of radiation is a microwave generator.

16. The method of claim 13 wherein said coarsely divided solid material is selected from the group of solid fuels consisting of coal, shale, peat, wood, and cellulosic biomass.

17. The method of claim 13 wherein said chamber has a vent for removing gases generated by irradiation and said method comprises the step of removing said gases through said vent.

18. The method of claim 13 wherein said chamber is in fluid communication with a source of inert gas and said method comprises the step of placing an inert gas in said chamber to reduce combustion.

19. The method of claim 18 wherein said inert gas is selected from the group comprising nitrogen and carbon dioxide.

20. The method of claim 13 wherein said apparatus further comprises a flow controller to control the rate of movement of said coarsely divided solid material through said chamber and said method comprises the step of controlling the movement of said coarsely divided solid material to subject said coarsely divided solid material to a predetermined amount of radiation.

21. The method of claim 20 wherein said flow controller is one or more gates which open or close or decrease the size of said exit opening to control the rate of the movement of said coarsely divided solid material.

22. The method of claim 20 wherein said flow controller is conveying means which receives said coarsely divided solid material and determined the rate of removal from said chamber.

23. The method of claim 22 wherein said conveying means is selected from one or more of the group of consisting of endless belts, rotating blades, moving vessels.

24. The method of claim 13 wherein said chamber is loaded with a coarsely divided solid material which has an angle of repose preventing said coarsely divided solid material from engaging said window allowing said coarsely divided solid material to be irradiated as said material passes said cavity by gravity.
